(19) United States
(12) Patent Application Publication
(10) Pub. No.: US 2026/0266102 A1
(43) Pub. Date: Sep. 10, 2026

(54) LATCH SYSTEM RESTRICTING RELATIVE MOVEMENT BETWEEN STRIKER AND LATCH

(71) Applicant: Atieva, Inc., Newark, CA (US)

(72) Inventor: Maheshkumar M. Patel, Foothill Ranch, CA (US)

(21) Appl. No.: 19/072,567

(22) Filed: Mar. 6, 2025

(51) Int. Cl. E05B 77/40; E05B 85/04; E05B 85/24

(52) U.S. Cl. CPC E05B 77/40; E05B 85/045; E05B 85/243

(57) ABSTRACT

A latch system comprises: a striker including an elongate member; and a latch assembly including a base and a first claw pivotally attached to the base, the first claw including a mouth configured to restrict the elongate member when the striker is in a latched position; wherein one of the elongate member or the mouth includes a protrusion, wherein another one of the elongate member or the mouth includes a recess, and wherein when the striker is in the latched position, the protrusion and the recess engage each other to restrict relative movement between the striker and the latch assembly in a direction along the elongate member.

### TECHNICAL FIELD

This document relates to a latch system that restricts relative movement between a striker and a latch.

### BACKGROUND

Latches are used in a broad range of situations to releasably join two or more objects to each other. One latch type that has been commonly used involves a rotatable claw with a groove that releasably catches a striker in the latched position.

### SUMMARY

In a first aspect, a latch system comprises: a striker including an elongate member; and a latch assembly including a base and a first claw pivotally attached to the base, the first claw including a mouth configured to restrict the elongate member when the striker is in a latched position; wherein one of the elongate member or the mouth includes a protrusion, wherein another one of the elongate member or the mouth includes a recess, and wherein when the striker is in the latched position, the protrusion and the recess engage each other to restrict relative movement between the striker and the latch assembly in a direction along the elongate member.

Implementations can include any or all of the following features. The protrusion comprises a ridge on the one of the elongate member or the mouth. The ridge has a shape selected from the group consisting of a V-shape, a U-shape, or a rectangular shape. The elongate member includes the ridge, and wherein the ridge extends over an entire periphery of a cross section profile of the elongate member. The elongate member includes the ridge, and wherein the ridge extends over one or more parts of a periphery of a cross section profile of the elongate member. The ridge extends over two parts of the periphery. The two parts of the periphery are aligned with each other in a direction that is parallel with an engagement direction of the striker when engaging the first claw. The two parts of the periphery are aligned with each other in a direction that is perpendicular to an engagement direction of the striker when engaging the first claw. The ridge extends over four parts of the periphery. A first part and a second part of the four parts of the periphery are aligned with each other in a direction that is parallel with an engagement direction of the striker when engaging the first claw, and wherein a third part and a fourth part of the four parts of the periphery are aligned with each other in a direction that is perpendicular to an engagement direction of the striker when engaging the first claw. The ridge traverses the elongate member in a direction that is perpendicular to a longitudinal axis of the elongate member. The ridge traverses the elongate member in a direction that is non-perpendicular to a longitudinal axis of the elongate member. The first claw includes a metal body covered by a polymer layer, and wherein the recess that is included in the mouth is formed in the polymer layer. The recess comprises a groove on the other one of the elongate member or the mouth. The groove has a shape selected from the group consisting of a V-shape, a U-shape, or a rectangular shape. The elongate member includes the groove, and wherein the groove extends over one or more parts of a periphery of a cross section profile of the elongate member. The groove extends over two parts of the periphery. The two parts of the periphery are aligned with each other in a direction that is parallel with an engagement direction of the striker when engaging the first claw. The two parts of the periphery are aligned with each other in a direction that is perpendicular to an engagement direction of the striker when engaging the first claw. The groove extends over four parts of the periphery. A first part and a second part of the four parts of the periphery are aligned with each other in a direction that is parallel with an engagement direction of the striker when engaging the first claw, and wherein a third part and a fourth part of the four parts of the periphery are aligned with each other in a direction that is perpendicular to an engagement direction of the striker when engaging the first claw. The protrusion comprises a pyramid shape extending from the one of the elongate member or the mouth. The pyramid shape has a rounded top. The pyramid shape has a truncated flat top. The pyramid shape is a four-sided pyramid shape. The pyramid shape is a three-sided pyramid shape. The striker comprises a wire member. The wire member has a cross section profile that is circular. The wire member has a cross section profile that is oval. A major axis of the cross section profile is parallel with an engagement direction of the striker when engaging the first claw. A major axis of the cross section profile is perpendicular to an engagement direction of the striker when engaging the first claw. The wire member has a cross section profile that is rectangular. The wire member has a cross section profile that is semi-circular. A flat side of the cross section profile faces in a direction that is parallel with an engagement direction of the striker when engaging the first claw. A flat side of the cross section profile faces in a direction that is antiparallel with an engagement direction of the striker when engaging the first claw. The first claw includes a metal body covered by a polymer layer, and wherein the protrusion or the recess that is included in the other one of the elongate member or the mouth is formed in the polymer layer. The one of the elongate member or the mouth includes first protrusions including the protrusion, and wherein the other one of the elongate member or the mouth includes first recesses including the recess. The elongate member includes the first protrusions, wherein the mouth includes the first recesses, wherein the elongate member further includes second recesses interspersed with the first protrusions, and wherein the mouth further includes second protrusions interspersed with the first recesses. The first protrusions and the second recesses are periodically arranged, and wherein the second protrusions and the first recesses are periodically arranged. The first protrusions or the first recesses on the elongate member are distributed over an entire periphery of a cross section profile of the elongate member. The first protrusions or the first recesses on the elongate member are distributed over only part of a periphery of a cross section profile of the elongate member. The first protrusions and the second recesses are included in an element attached to the elongate member. The first recesses and the second protrusions are included in an element attached to the mouth.

In a second aspect, a vehicle comprises: a vehicle body; a component moveable relative to the vehicle body; and a latch system configured for releasably securing the component in a closed position, the latch system comprising: a first striker including an elongate member; and a first latch assembly including a base and a first claw pivotally attached to the base, the first claw including a mouth configured to restrict the elongate member when the first striker is in a latched position; wherein one of the elongate member or the mouth has a protrusion, wherein another one of the elongate member or the mouth has a recess, and wherein when the first striker is in the latched position, the protrusion and the recess engage each other to restrict relative movement between the first striker and the first latch assembly in a direction along the elongate member.

Implementations can include any or all of the following features. The first striker is on the component and wherein the first latch assembly is on the vehicle body. The first striker is on the vehicle body and wherein the first latch assembly is on the component. The latch system further comprises a second striker and a second latch assembly for the second striker. The latch system further comprises a third striker and a third latch assembly for the third striker. The component is a hood of the vehicle. The component is a liftgate of the vehicle. The component is a seat recliner of the vehicle. The component is a glove box lid of the vehicle. The component is a console lid of the vehicle. The component is a moveable display device of the vehicle. The component is a door of an aircraft luggage stowage bin of the vehicle. The component is a cargo deployment door of the vehicle. The component is a space satellite door of the vehicle.

### BRIEF DESCRIPTION OF DRAWINGS

FIG. 1 shows an example of a striker.

FIG. 2 shows an example of a claw of a latch assembly.

FIG. 3 shows an example of a latch system where three translational degrees of freedom out of three are restricted.

FIG. 4A shows an example of a vehicle that can have one or more latch systems.

FIG. 4B schematically shows another example of a vehicle that can have one or more latch systems.

FIG. 5 schematically shows an example of a latch system for a vehicle of FIGS. 4A-4B having a first orientation relative to the vehicle.

FIG. 6 schematically shows an example of a latch system for a vehicle of FIGS. 4A-4B having a second orientation relative to the vehicle.

FIG. 7 shows an example of a computer simulation where a latch assembly does not restrict relative motion between a striker and a claw.

FIG. 8 shows an example of a computer simulation where a latch assembly restricts relative motion between a striker and a claw.

FIG. 9 shows an example of a latch system that restricts relative motion between a striker and a claw, the latch system being in an unlatched position.

FIG. 10 shows an example of the latch system of FIG. 9 in a latched position.

FIG. 11 shows an example of a dual claw latch system that restricts relative motion between a striker and claws, the latch system being in an unlatched position.

FIG. 12 shows an example of the latch system of FIG. 11 in a latched position.

FIG. 13 shows an example of an insert for a claw and an insert for a striker.

FIG. 14 shows an example of a striker with ridges.

FIG. 15 shows examples of shapes for the ridges of the striker of FIG. 14.

FIG. 16 shows another example of a striker with ridges.

FIG. 17A shows an example of protrusions having a four-sided pyramid shape.

FIG. 17B shows an example of the protrusions of FIG. 17A applied to a striker and a claw.

FIG. 17C shows a perspective view of one of the protrusions of FIG. 17A.

FIG. 17D shows a perspective view of a four-sided pyramid shape having a rounded top.

FIG. 17E shows a perspective view of a four-sided pyramid shape having a truncated flat top.

FIG. 18A shows an example of protrusions having a three-sided pyramid shape.

FIG. 18B shows an example of the protrusions of FIG. 18A applied to a striker and a claw.

FIG. 18C shows a perspective view of one the protrusions of FIG. 18A.

FIG. 18D shows a perspective view of a three-sided pyramid shape having a rounded top.

FIG. 18E shows a perspective view of a three-sided pyramid shape having a truncated flat top.

FIG. 19A shows a cross section profile of a striker having protrusions that extend over an entire periphery of the cross section profile.

FIG. 19B shows a cross section profile of a striker having protrusions that extend over two parts of a periphery of the cross section profile.

FIG. 19C shows a cross section profile of a striker having protrusions that extend over two parts of a periphery of the cross section profile.

FIG. 19D shows a cross section profile of a striker having protrusions that extend over four parts of a periphery of the cross section profile.

FIG. 20A shows an example of a cross section profile of a striker that is circular.

FIG. 20B shows an example of a cross section profile of a striker that is oval.

FIG. 20C shows an example of a cross section profile of a striker that is rectangular.

FIG. 20D shows an example of a cross section profile of a striker that is semi-circular.

FIG. 20E shows another example of a cross section profile of a striker that is semi-circular.

FIG. 20F shows another example of a cross section profile of a striker that is oval.

FIG. 20G shows another example of a cross section profile of a striker that has a truncated circle shape.

FIG. 20H shows another example of a cross section profile of a striker that has an octagonal shape.

FIG. 20I shows another example of a cross section profile of a striker that has a truncated semicircle shape whose larger planar surface faces along an engagement direction of the striker when engaging the claw.

FIG. 20J shows another example of a cross section profile of a striker that has a truncated semicircle shape whose larger planar surface faces opposite to an engagement direction of the striker when engaging the claw.

FIG. 21 shows an example cross section of a claw including a metal body covered by a polymer layer.

FIG. 22 schematically shows an example of a latch system having a striker and a latch assembly.

FIG. 23 schematically shows an example of a latch system having strikers and latch assemblies.

FIG. 24 schematically shows an example of a latch system having strikers and latch assemblies.

FIG. 25A shows a cross section profile of a striker having recesses that extend over an entire periphery of the cross section profile.

FIG. 25B shows a cross section profile of a striker having recesses that extend over two parts of a periphery of the cross section profile.

FIG. 25C shows a cross section profile of a striker having recesses that extend over two parts of a periphery of the cross section profile.

FIG. 25D shows a cross section profile of a striker having recesses that extend over four parts of a periphery of the cross section profile.

Like reference symbols in the various drawings indicate like elements.

### DETAILED DESCRIPTION

This document describes examples of systems and techniques for restricting relative movement in at least one additional degree of freedom between a striker and a latch of a latch system. Such approaches can reduce or eliminate unwanted displacement and/or reduce or eliminate noise or vibrations that may otherwise occur. In some implementations, protrusions are formed on at least one of the striker and the latch to engage with corresponding recesses on the other one of the striker and the latch. The protrusions/recesses can be arranged in a regular (e.g., periodic) pattern or in a pseudorandom distribution or completely random distribution. The protrusions/recesses can be formed by knurling, molding or broaching, to name just a few examples.

As used herein, a vehicle is a machine or an object that transports passengers or cargo/payload, or both. A vehicle can have one or more motors or engines or devices used for propulsion. Examples of vehicles include, but are not limited to, cars, trucks, buses, motorcycles, scooters, airplanes, spacecrafts, space vehicles and space satellites. For wheeled vehicles, the number of wheels can differ between types of vehicles, and one or more (e.g., all) of the wheels can be used for propulsion of the vehicle, whereas for some vehicles (e.g., spacecrafts) wheels are optional. The vehicle can include one or more passenger/cargo/stowage compartments accommodating one or more persons or no persons.

Examples described herein refer to a top, bottom, front, or rear. These and similar expressions identify things or aspects in a relative way based on an express or arbitrary notion of perspective. That is, these terms are illustrative only, used for purposes of explanation, and do not necessarily indicate the only possible position, direction, and so on.

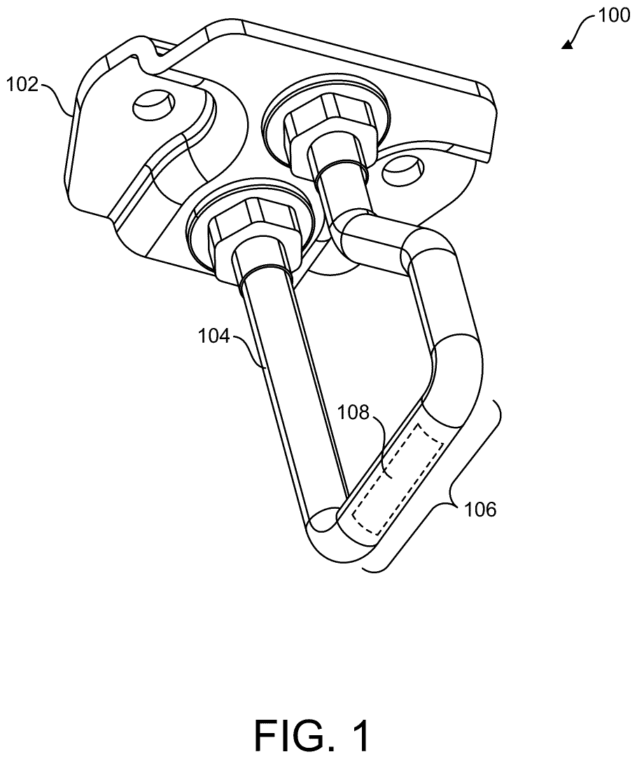

FIG. 1 shows an example of a striker 100. The striker 100 can be used with one or more other examples described elsewhere herein. The striker 100 can include a base 102 (e.g., for attaching the striker 100 to another structure) having a wire member 104 attached thereto. The wire member 104 can be attached to the base 102 at either or both of its ends. The wire member 104 can have a cross section profile of any shape; here the profile is circular. In some implementations, the wire member 104 can be shaped in one or more ways to define an elongate member 106. The elongate member 106 can be attached to the wire member 104 at either or both of its ends. For example, the wire member 104 can be bent so the elongate member 106 is formed between respective ends of the wire member 104 that are attached to the base 102.

The wire member 104 can include at least one area 108 on the elongate member 106 that is designed for restricting relative movement in at least one additional degree of freedom. In some implementations, the area 108 can include at least one protrusion and/or at least one recess. For example, the at least one area 108 can include multiple protrusions spaced from each other so that recesses are formed between the protrusions. The at least one area 108 can extend over all or only some portions of the elongate member 106.

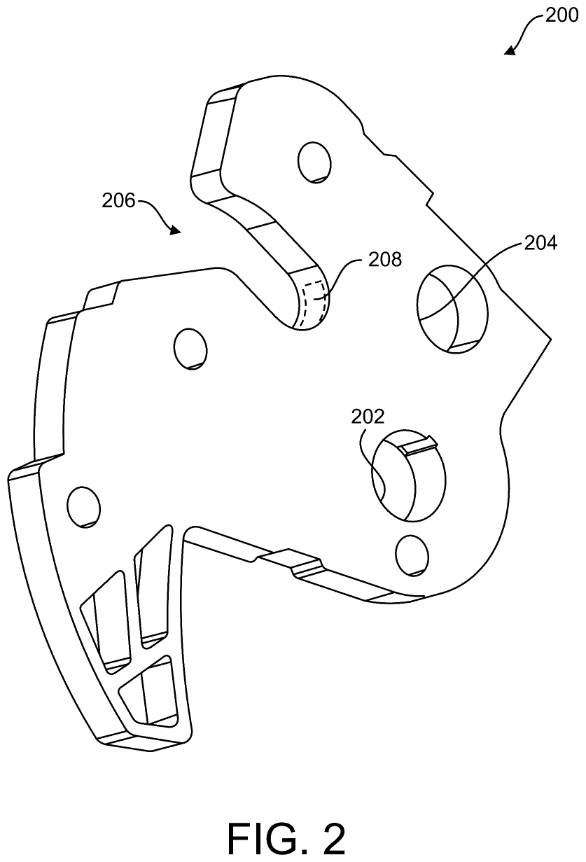

FIG. 2 shows an example of a claw 200 of a latch assembly. The claw 200 can be used with one or more other examples described elsewhere herein. The claw 200 can be formed of a metal body (e.g., a piece of sheet metal stamped to form a geometry). In some implementations, a metal body of the claw 200 can be coated with a polymer material. For example, the metal body can be over-molded with a plastic material. The claw 200 can be configured to be rotatably mounted about an opening 202. The claw 200 can also have one or more other openings 204.

The claw 200 has a mouth 206 that is configured for releasably holding a striker (e.g., the striker 100 of FIG. 1) when a latch system is in a latched position. For example, the mouth 206 can be created by cutting or otherwise forming a shape opening into the body of the claw 200, the shape having a size suitable to accommodate an elongate member of the striker.

In the claw 200, at least one area 208 of the mouth 206 can be designed for restricting relative movement in at least one additional degree of freedom. In some implementations, the area 208 can include at least one protrusion and/or at least one recess. For example, the at least one area 208 can include multiple protrusions spaced from each other so that recesses are formed between the protrusions. A protrusion or recess of the at least one area 208 can engage with a corresponding recess or protrusion at the at least one area 108 of FIG. 1 to restrict additional relative movement. The at least one area 208 can extend over all or only some portions of the mouth 206.

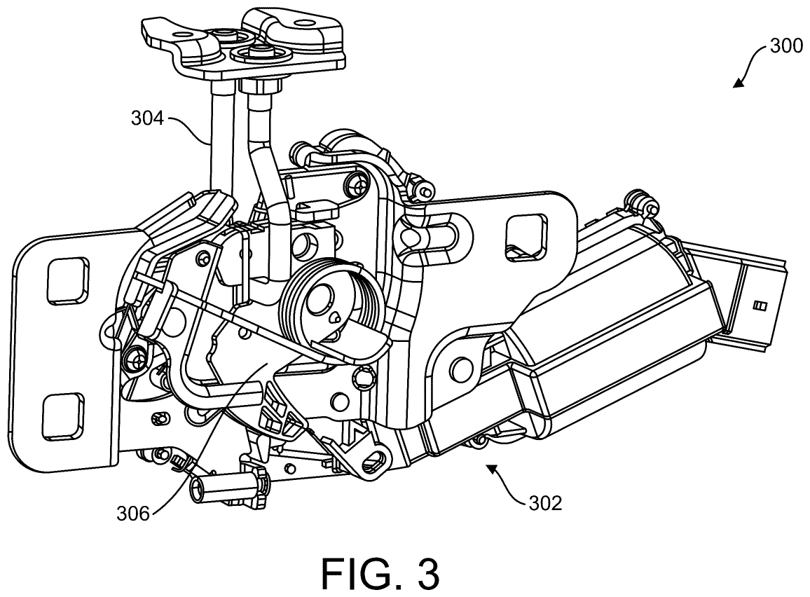

FIG. 3 shows an example of a latch system 300 where three translational degrees of freedom out of three are restricted. In previous approaches to latch systems one translational degree of freedom—along the elongate member of the striker—may have been unrestricted in the latched state, allowing displacements and/or vibrations to occur. The latch system 300, by contrast, restricts all translational degrees of freedom. The latch system 300 can be used with one or more other examples described elsewhere herein.

The latch system 300 includes a latch assembly 302 that includes a base configured for releasably holding a striker 304 (e.g., the striker 100 of FIG. 1) using a claw 306 (e.g., the claw 200 of FIG. 2). The claw 306 can define a mouth configured to restrict an elongate member of the striker 304 when the striker 304 is in a latched position. From the latched position, the latch system 300 can be unlatched so that the striker 304 assumes an unlatched position where the claw 306 does not restrict movement of the striker 304. For example, the unlatching can be done by manually and/or electronically actuating the latch assembly 302 to cause the claw 306 to disengage the elongate member of the striker 304.

The above examples illustrate that a latch system (e.g., the latch system 300) can include: a striker (e.g., the striker 304) including an elongate member (e.g., the elongate member 106 of FIG. 1); a latch assembly (e.g., the latch assembly 302) including a base and a claw (e.g., the claw 306) pivotally attached to the base, the claw including a mouth (e.g., the mouth 206 of FIG. 2) configured to restrict the elongate member when the striker is in a latched position; wherein one of the elongate member (e.g., at the at least one area 108 of FIG. 1) or the mouth (e.g., at the at least one area 208 of FIG. 2) includes a protrusion, wherein another one of the elongate member (e.g., at the at least one area 108 of FIG. 1) or the mouth (e.g., at the at least one area 208 of FIG. 2) includes a recess, and wherein when the striker is in the latched position (e.g., as shown in FIG. 3), the protrusion and the recess engage each other to restrict relative movement between the striker and the latch assembly in a direction along the elongate member. Depending on the protrusions and recess shapes, the engagement can also restrict relative motion in the rotation direction of the elongated member.

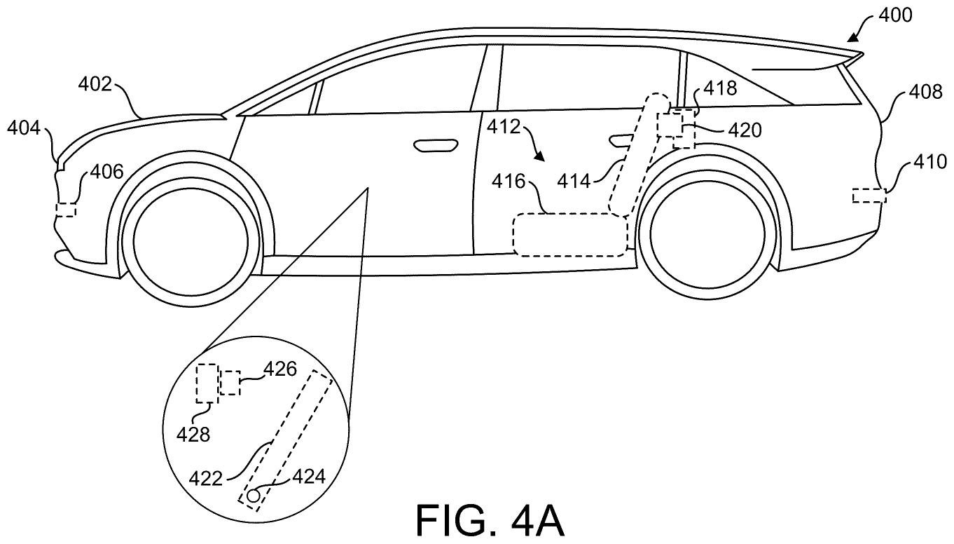

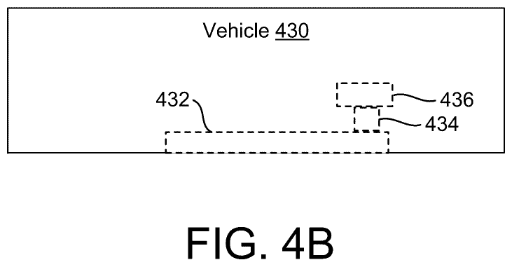

FIG. 4A shows an example of a vehicle 400 that can have one or more latch systems. The vehicle 400 can be used with one or more other examples described elsewhere herein. The vehicle 400 includes a vehicle body to which one or more closures and/or other components are attached.

Here, one closure attached to the body of the vehicle 400 is a hood 402. For example, the hood 402 can cover a motor or a storage compartment of the vehicle 400. The hood 402 is hinged to the vehicle body toward the rear of the hood 402 using one or more hinges. At the front end of the vehicle 400 the hood 402 extends downward to form a substantially vertical portion in form of a drop nose 404. One or more latches can be mounted in the area of the drop nose 404 to selectively place the hood 402 in a latched position. A latch system 406 may be obscured when the hood 402 is closed and is here schematically illustrated and shown in phantom. In some implementations, the latch system 406 can include the latch system 300 of FIG. 3. The latch system 406 can restrict movement of the hood 402 and can reduce or eliminate unwanted displacement and/or vibrations.

Here, another closure attached to the body of the vehicle 400 is a liftgate 408. For example, the liftgate 408 can cover a rear opening of the vehicle 400 (e.g., for access to a storage compartment or to the passenger cabin). The liftgate 408 is hinged to the vehicle body toward the top of the liftgate 408 using one or more hinges. One or more latches can be mounted toward the bottom end of the liftgate 408 to selectively place the liftgate 408 in a latched position. A latch system 410 may be obscured when the liftgate 408 is closed and is here schematically illustrated and shown in phantom. In some implementations, the latch system 410 can include the latch system 300 of FIG. 3. The latch system 410 can restrict movement of the liftgate 408 and can reduce or eliminate unwanted displacement and/or vibrations.

The vehicle 400 can include one or more seats moveable to different positions. A seat 412 is a second-row seat of the vehicle 400 that is obscured when a door is closed and is here schematically illustrated and shown in phantom. The seat 412 includes a seat recliner 414 (e.g., a backrest) that is rotatably mounted to a seat cushion 416. To accommodate an occupant to sit in the seat 412 the seat recliner 414 can be secured to a body member 418 of the vehicle body to prevent rotation. A latch system 420 (e.g., the latch system 300 of FIG. 3) can be provided to secure the seat recliner 414 and the body member 418 to each other.

The vehicle 400 can include a component 422 that is obscured when a door is closed and is here schematically illustrated in an inset view and shown in phantom. The component 422 is rotatably mounted about a pivot 424 (e.g., one or more hinges). A latch system 426 (e.g., the latch system 300 of FIG. 3) can be provided to secure the component 422 and a structure 428 of the body of the vehicle 400 to each other. In some implementations, the component 422 is a glove box lid of the vehicle 400. In some implementations, the component 422 is a console lid of the vehicle 400 (e.g., for a center console). In some implementations, the component 422 is moveable display device of the vehicle 400 (e.g., a folding/pivoting/moving screen). Other approaches can be used.

FIG. 4B schematically shows another example of a vehicle 430 that can have one or more latch systems. The vehicle 430 can be used with one or more other examples described elsewhere herein. The vehicle 400, which is schematically shown for simplicity, includes a vehicle body to which one or more closures and/or other components are attached. The vehicle 430 can include a component 432 on the inside or the outside of the vehicle body, the component 432 here schematically illustrated and shown in phantom. The component 432 is rotatably mounted to the body of the vehicle 430. A latch system 434 (e.g., the latch system 300 of FIG. 3) can be provided to secure the component 432 and a structure 436 of the body of the vehicle 430 to each other.

In some implementations, the vehicle 430 is an aircraft or a spacecraft. For example, the component 432 is the door of an aircraft luggage stowage bin of the vehicle 430. As another example, the component 432 is a cargo deployment door of the vehicle 430. As another example, the component 432 is a space satellite door of the vehicle 430. As another example, the component 432 is a folding mechanism of the vehicle 430. Other approaches can be used.

The above examples illustrate that a vehicle (e.g., the vehicle 400) can include: a vehicle body (e.g., the body of the vehicle 400); a component (e.g., the hood 402, the liftgate 408 or the seat recliner 414) moveable relative to the body; and a latch system (e.g., the latch system 300 of FIG. 3) configured for releasably securing the component in a closed position, the latch system comprising: a striker (e.g., the striker 100 of FIG. 1) including an elongate member (e.g., the elongate member 106 of FIG. 1); and a latch assembly (e.g., the latch assembly 302 of FIG. 3) including a base and a claw (e.g., the claw 200 of FIG. 2) pivotally attached to the base, the claw including a mouth (e.g., the mouth 206 of FIG. 2) configured to restrict the elongate member when the striker is in a latched position; wherein one of the elongate member (e.g., at the at least one area 108 of FIG. 1) or the mouth (e.g., at the at least one area 208 of FIG. 2) has a protrusion, wherein another one of the elongate member (e.g., at the at least one area 108 of FIG. 1) or the mouth (e.g., at the at least one area 208 of FIG. 2) has a recess, and wherein when the striker is in the latched position, the protrusion and the recess engage each other to restrict relative movement between the striker and the latch assembly in a direction along the elongate member.

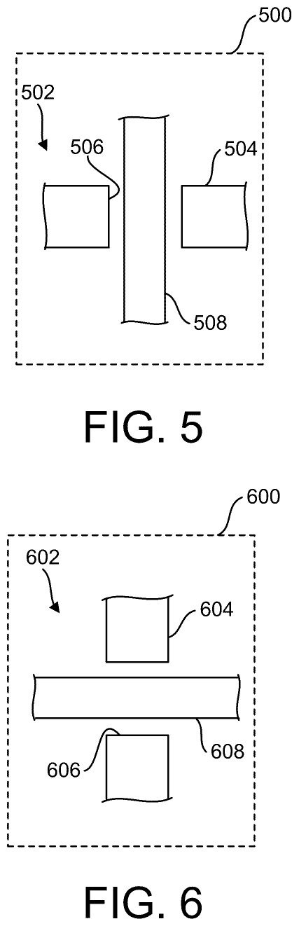

FIG. 5 schematically shows an example of a latch system 500 for a vehicle of FIG. 4A or 4B having a first orientation relative to the vehicle. The latch system 500 can be used with one or more other examples described elsewhere herein. The latch system 500 is schematically illustrated for simplicity and is shown to include a latch assembly 502 including a claw 504 that defines a mouth 506 for releasably holding a striker 508 (e.g., an elongate member thereof). The striker 508 is here oriented so the elongate member extends transversely across the vehicle (in a y-direction of a vehicle coordinate system). As such, the latch system 500 can use one or more protrusions and recesses to restrict relative movement between the latch assembly 502 and the striker 508 in the y-direction.

FIG. 6 schematically shows an example of a latch system 600 for a vehicle of FIG. 4A or 4B having a second orientation relative to the vehicle. The latch system 600 can be used with one or more other examples described elsewhere herein. The latch system 600 is schematically illustrated for simplicity and is shown to include a latch assembly 602 including a claw 604 that defines a mouth 606 for releasably holding a striker 608 (e.g., an elongate member thereof). The striker 608 is here oriented so the elongate member extends longitudinally along a travel direction of the vehicle (in an x-direction of a vehicle coordinate system). As such, the latch system 600 can use one or more protrusions and recesses to restrict relative movement between the latch assembly 602 and the striker 608 in the x-direction.

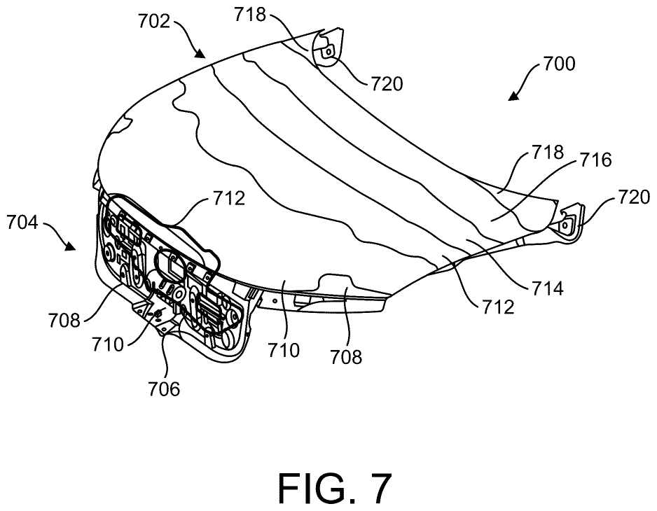

FIG. 7 shows an example of a computer simulation 700 where a latch assembly does not restrict relative motion between a striker and a claw. The computer simulation 700 shows a hood of a vehicle that includes a main hood portion 702 (e.g., that is substantially horizontal when the hood is closed) and a drop nose portion 704 (e.g., that is substantially vertical when the hood is closed). The drop nose portion 704 can be narrower in a y-direction than the main hood portion 702. Here, a striker 706 attached to the hood is partially obscured and oriented so its elongate member extends along the x-direction of the vehicle. The hood is latched during the simulation but the degree of freedom between the striker 706 and a claw of the latch assembly is not restricted using a protrusion and recess according to the present subject matter. The computer simulation 700 shows the results of simulating aerodynamic loads on the hood when the vehicle is traveling at about 80 miles per hour (mph).

The computer simulation 700 indicates displacement of the various portions of the hood. The displacement can occur in any direction. In some implementations, the main displacements of the computer simulation 700 are that the main hood portion 702 is displaced upward (in the z-direction) and that the drop nose portion 704 is displaced rearward (in the x-direction) due to deformation of the hood. Areas 708 correspond to the greatest amount of displacement. For example, the areas 708 are located at the drop nose portion 704 and toward the front edge of the main hood portion 702. Areas 710 correspond to displacement less than that of the areas 708. For example, the areas 710 are located at the latch area of the drop nose portion 704 and across the forwardmost area of the main hood portion 702. Areas 712 correspond to displacement less than that of the areas 710. For example, the areas 712 are located toward the top of the drop nose portion 704 and rearward of the forwardmost area of the main hood portion 702. Areas 714 correspond to displacement less than that of the areas 712. For example, the areas 714 are located rearward of the areas 712 of the main hood portion 702. Areas 716 correspond to displacement less than that of the areas 714. For example, the areas 716 are located rearward of the areas 714 of the main hood portion 702. Areas 718 correspond to displacement less than that of the areas 716. For example, the areas 718 are located rearward of the areas 716 of the main hood portion 702. Areas 720 correspond to displacement less than that of the areas 718. For example, the areas 720 are located at the rear end of the main hood portion 702 where the hood is hinged (i.e., attached to) the vehicle body.

The displacements represented by at least some of the areas 708-720 can be substantial. In some implementations, the computer simulation 700 can indicate maximum displacements on the order of about 5-10 millimeter (mm) as a result of the aerodynamic effects on the hood. For example, the displacement(s) can result from aerodynamic lift on the main hood portion 702, from aerodynamic pressure on the drop nose portion 704, or combinations thereof.

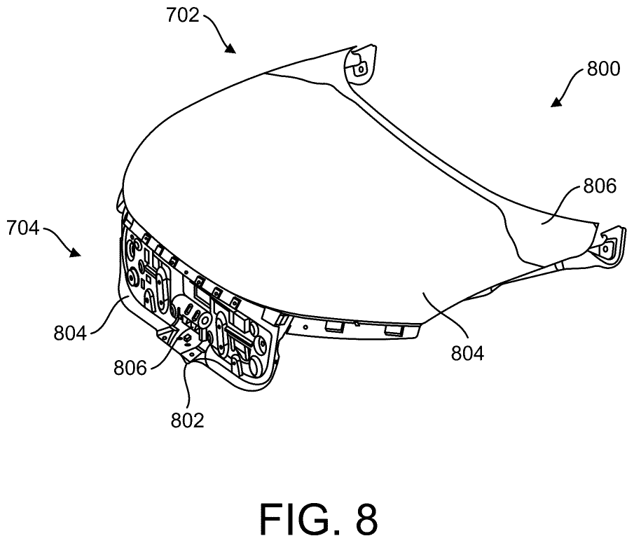

FIG. 8 shows an example of a computer simulation 800 where a latch assembly restricts relative motion between a striker and a claw. The computer simulation 800 can include the main hood portion 702 and the drop nose portion 704 as in the computer simulation 700 with the difference that the hood instead has a striker 802 (e.g., the striker 100 of FIG. 1) with one or more protrusions and/or recesses to prevent relative movement, the striker engaging with a latch assembly which is not shown for simplicity (e.g., the latch assembly 302 of FIG. 3). The computer simulation 800 shows the results of simulating the aerodynamic load on the hood when the vehicle is traveling at about 80 mph.

The computer simulation 800 indicates displacement of the various portions of the hood. The displacement can occur in any direction and is exemplified in the following. Areas 804 correspond to the greatest amount of displacement. For example, the displacement of the areas 804, which covers substantially all of the main hood portion 702 and most of the drop nose portion 704, is about equal to the amount of displacement of the areas 718 in FIG. 7. Areas 806 correspond to displacement less than that of the areas 804. For example, the areas 806 are located at the latch area of the drop nose portion 704 and at the rearmost area of the main hood portion 702, and their displacement is about equal to the amount of displacement of the areas 720 in FIG. 7. That is, the latch system that restricts additional relative motion between the striker 802 and a claw of the latching system can significantly reduce or eliminate unwanted displacement of the hood.

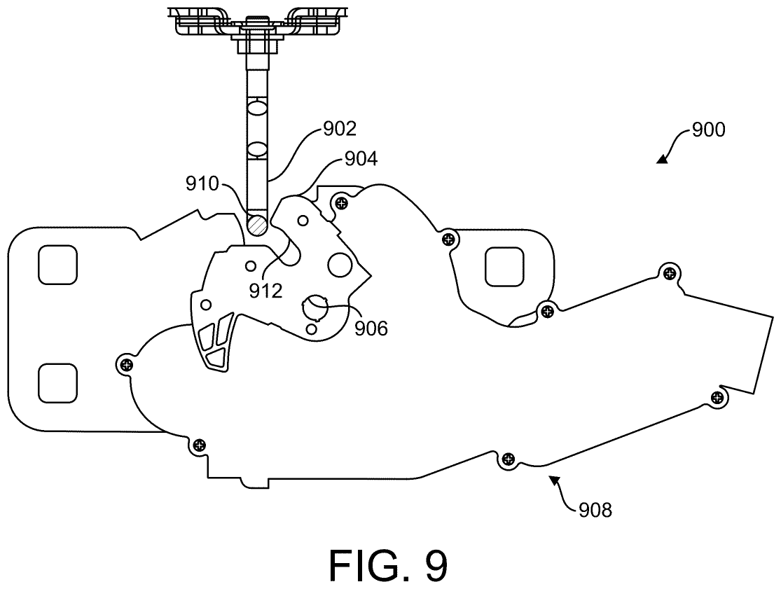

FIG. 9 shows an example of a latch system 900 that restricts additional relative motion between a striker 902 and a claw 904, the latch system 900 being in an unlatched position. The latch system 900 can be used with one or more other examples described elsewhere herein. The latch system 900 is schematically shown, including partially in section, and is consistent with latch systems as described herein.

The claw 904 is rotatably mounted about an axis 906 of a body of a latch assembly 908. The striker 902 has an elongate member 910 to be restricted by a mouth 912 of the claw 904. In the current illustration, there is relative movement between the striker 902 and the latch assembly 908 so that the elongate member 910 is about to begin acting on the mouth 912 to cause the claw 904 to rotate about the axis 906. The elongate member 910 and the mouth 912 have at least one protrusion or recess, respectively, as described elsewhere herein.

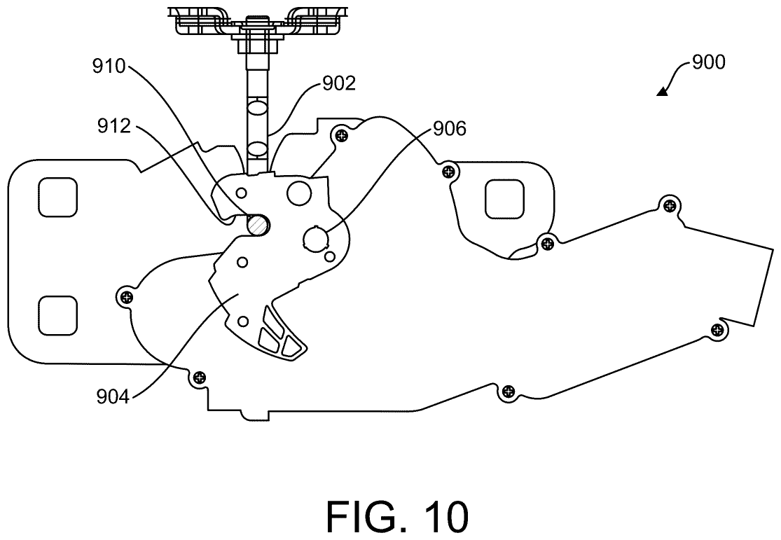

FIG. 10 shows an example of the latch system 900 of FIG. 9 in a latched position. Here, the elongate member 910 of the striker 902 has caused the claw 904 to rotate about the axis 906 so that the mouth 912 of the claw 904 engages with the elongate member 910. In this latched position, the at least one protrusion or recess, respectively, of the elongate member 910 and the mouth 912 engage with each other to restrict additional relative movement along the elongate member 910.

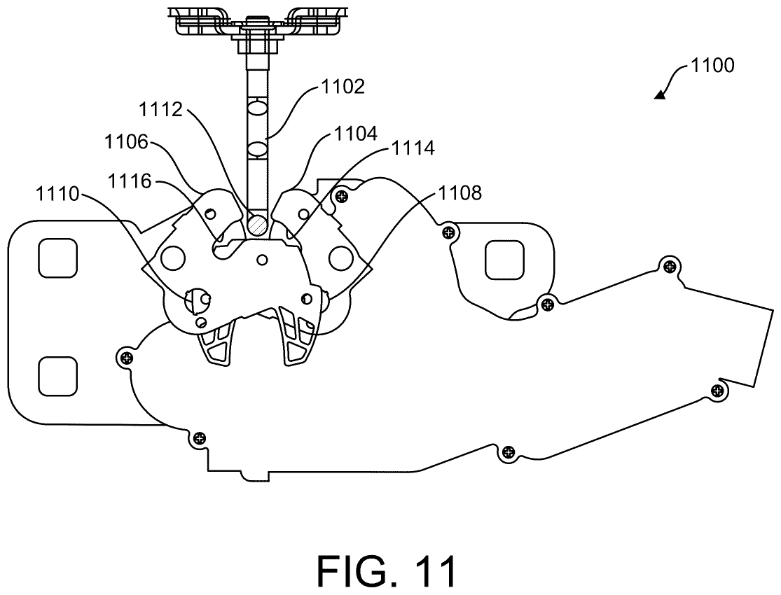

FIG. 11 shows an example of a dual claw latch system 1100 that restricts relative motion between a striker 1102 and claws 1104 and 1106, the dual claw latch system 1100 being in an unlatched position. The dual claw latch system 1100 can be used with one or more other examples described elsewhere herein. The dual claw latch system 1100 is schematically shown, including partially in section, and is consistent with latch systems as described herein.

The claw 1104 is rotatably mounted about an axis 1108 of a body of a latch assembly. The claw 1106 is rotatably mounted about an axis 1110 of the body of the latch assembly. The striker 1102 has an elongate member 1112 to be restricted by a mouth 1114 of the claw 1104, and by a mouth 1116 of the claw 1106. The elongate member 1112 and the mouths 1114-1116 have at least one protrusion or recess, respectively, as described elsewhere herein.

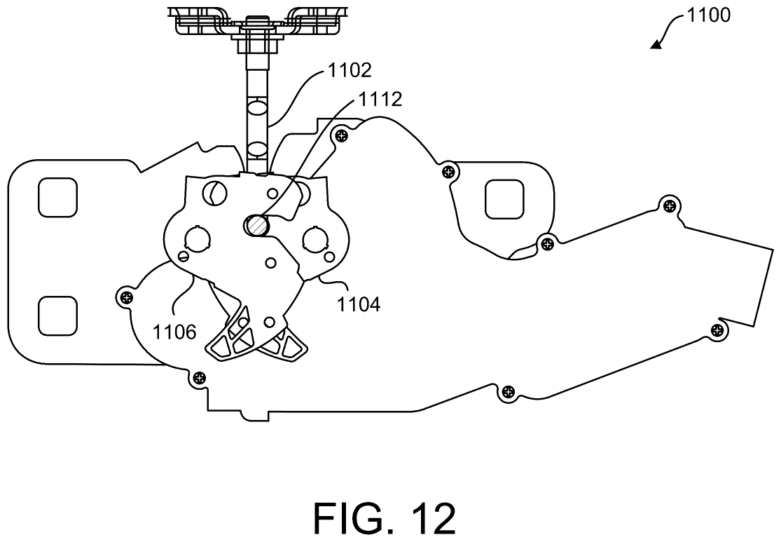

FIG. 12 shows an example of the dual claw latch system 1100 of FIG. 11 in a latched position. Here, the elongate member 1112 of the striker 1102 has caused each of the claws 1104 and 1106 to rotate about its respective axis so that their respective mouths engage with the elongate member 1112. In this latched position, the at least one protrusion or recess, respectively, of the elongate member 1112 and the respective mouths with each other to restrict relative movement along the elongate member 1112.

FIG. 13 shows an example of an insert 1300 for a claw and an insert 1302 for a striker. The insert 1300 and/or the insert 1302 can be used with one or more other examples described elsewhere herein. In some implementations, the insert 1300 and/or the insert 1302 can serve as an element that provides a protrusion and/or recess, the element to be added to a claw or striker, as the case may be, that does not otherwise have a protrusion and/or recess. The insert 1300 can be made of any of multiple materials including, but not limited to, plastic or metal.

The insert 1300 can include a rounded shape 1304 designed to fit in the interior of a mouth of a claw. For example, the insert 1300 can be fitted inside the mouth 206 of FIG. 2 to provide the claw 200 with a protrusion and/or recess. The insert 1300 can be provided with protrusions 1306 (e.g., ridges) interspersed with recesses 1308 (e.g., grooves). The protrusions 1306 and the recesses 1308 can be provided on the face of the insert 1300 that is on the inside of the rounded shape 1304 so that they face away from the claw when the insert 1300 is installed in the claw. The protrusions 1306 and/or the recesses 1308 can be periodically arranged on the insert 1300.

The insert 1302 can include a clamshell 1310 and a clamshell 1312 designed to fit about the periphery of an elongated member of a striker to provide the striker with a protrusion and/or recess. The insert 1302 can be provided with protrusions 1314 (e.g., ridges) interspersed with recesses 1316 (e.g., grooves). The protrusions 1314 and the recesses 1316 can be provided on the exterior face of the insert 1302 so that they face outward from the elongated member when the insert 1302 is installed. The protrusions 1314 and/or the recesses 1316 can be periodically arranged on the insert 1302.

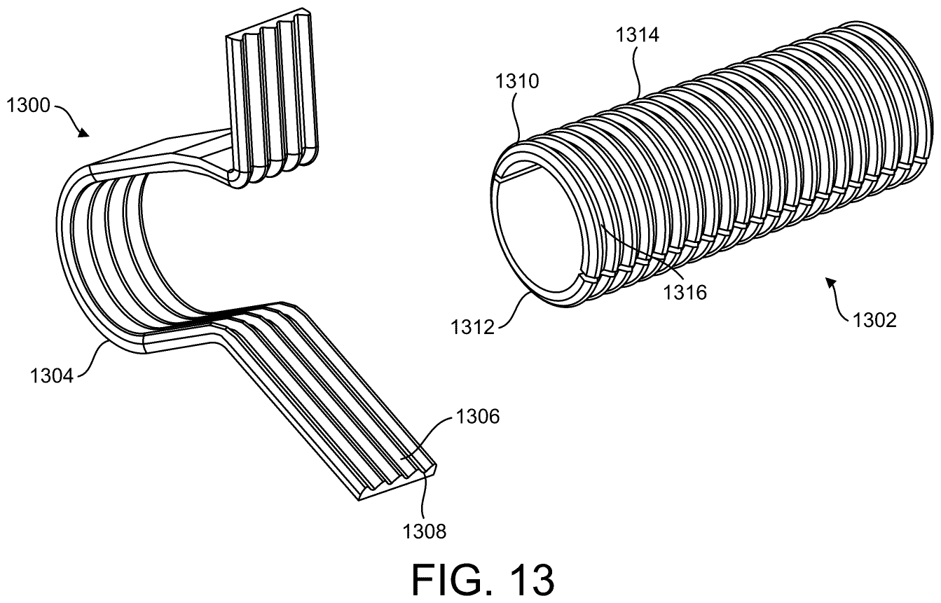

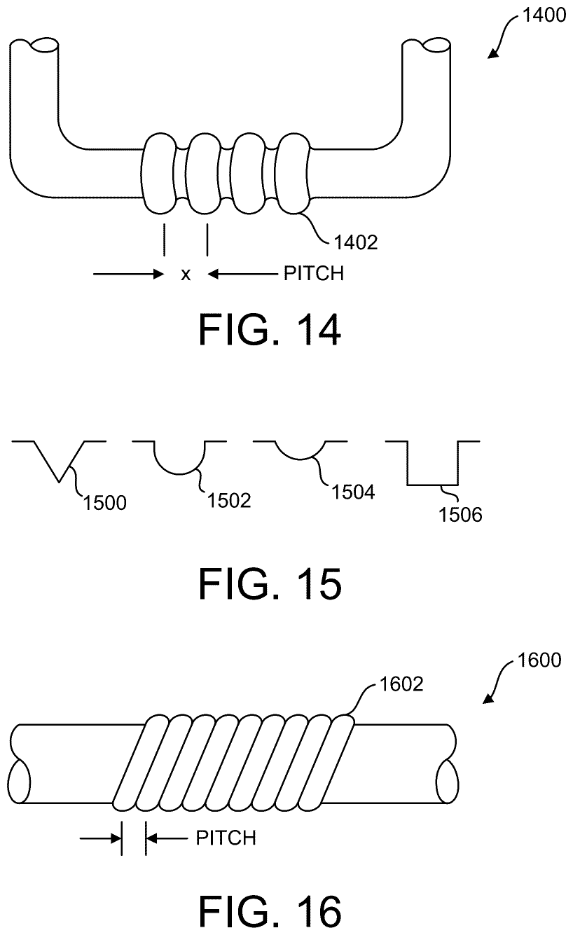

FIG. 14 shows an example of a striker 1400 with ridges 1402. The striker 1400 can be used with one or more other examples described elsewhere herein. The ridges 1402 are formed on an elongate member that is part of the striker 1400. The ridges 1402 can extend over (e.g., be distributed over) an entire periphery of a cross section profile of the elongate member. For example, the ridges 1402 extend also over the far side of the elongate member that is not visible in the illustration. Here, each of the ridges 1402 traverses the elongate member in a direction that is perpendicular to a longitudinal axis of the elongate member. For example, if each of the ridges 1402 is characterized as essentially having the shape of a cylinder or torus surrounding the elongate member, then the longitudinal axis of the elongate member coincides with a center axis of the cylinder or torus. The ridges 1402 can be arranged with any of multiple pitches, the pitch indicating the distance from one of the ridges 1402 to the adjacent one of the ridges 1402. In some implementations, a pitch in the range of, but not limited to, about 0.5-5 mm can be used.

FIG. 15 shows examples of shapes 1500-1506 for the ridges 1402 of the striker 1400 of FIG. 14. A shape 1500 is a V-shape. A shape 1502 is a U-shape. A shape 1504 is a shallow U-shape. A shape 1506 is a rectangular (e.g., square) shape. Other shapes can be used. In some implementations, any or all of the shapes 1500-1506 can instead be used for the ridges of a claw (e.g., the claw 200 of FIG. 2).

FIG. 16 shows another example of a striker 1600 with ridges 1602. The striker 1600 can be used with one or more other examples described elsewhere herein. The ridges 1602 are formed on an elongate member that is part of the striker 1600. The ridges 1602 can extend over an entire periphery of a cross section profile of the elongate member. For example, the ridges 1602 extend also over the far side of the elongate member that is not visible in the illustration. Here, each of the ridges 1602 traverses the elongate member in a direction that is non-perpendicular to a longitudinal axis of the elongate member. For example, if each of the ridges 1602 is characterized as essentially having the shape of a cylinder or torus surrounding the elongate member, then the longitudinal axis of the elongate member does not coincide with (i.e., forms a nonzero angle with) a center axis of the cylinder or torus. The ridges 1602 can be arranged with any of multiple pitches.

In some implementations, at least one protrusion can comprise a pyramid shape. This can provide a reliable engagement between the protrusion and a recess, and/or facilitate easy manufacturability. Examples are provided below.

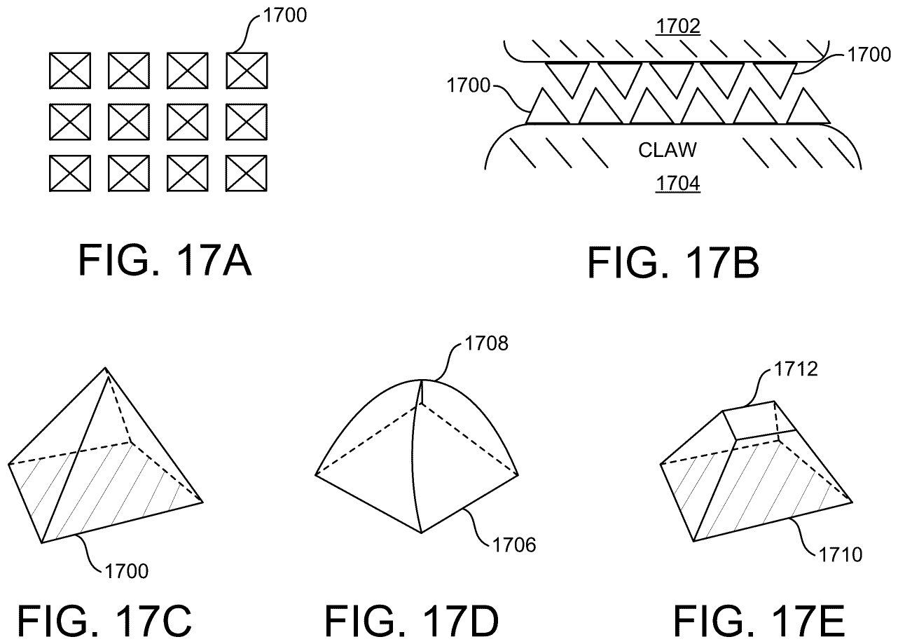

FIG. 17A shows a top view of an example of protrusions 1700 having a four-sided pyramid shape. The protrusions 1700 can be used with one or more other examples described elsewhere herein. The protrusions 1700 can be arranged in a periodic pattern. For example, the protrusions 1700 can be arranged in a grid shape. FIG. 17B shows an example of the protrusions 1700 of FIG. 17A applied to a striker 1702 and a claw 1704. That is, here both the striker 1702 and the claw 1704 have the protrusions 1700, with adjacent ones of the protrusions 1700 forming recesses for engagement. FIG. 17C shows a perspective view of one the protrusions 1700 of FIG. 17A. The one the protrusions 1700 is here shown partially transparent for clarity. The protrusion 1700 can be a solid body (e.g., of a metal or plastic material). For example, the protrusion 1700 can be formed by knurling (e.g., of a metal material). FIG. 17D shows a perspective view of a four-sided pyramid shape 1706 having a rounded top 1708. FIG. 17E shows a perspective view of a four-sided pyramid shape 1710 having a truncated flat top 1712.

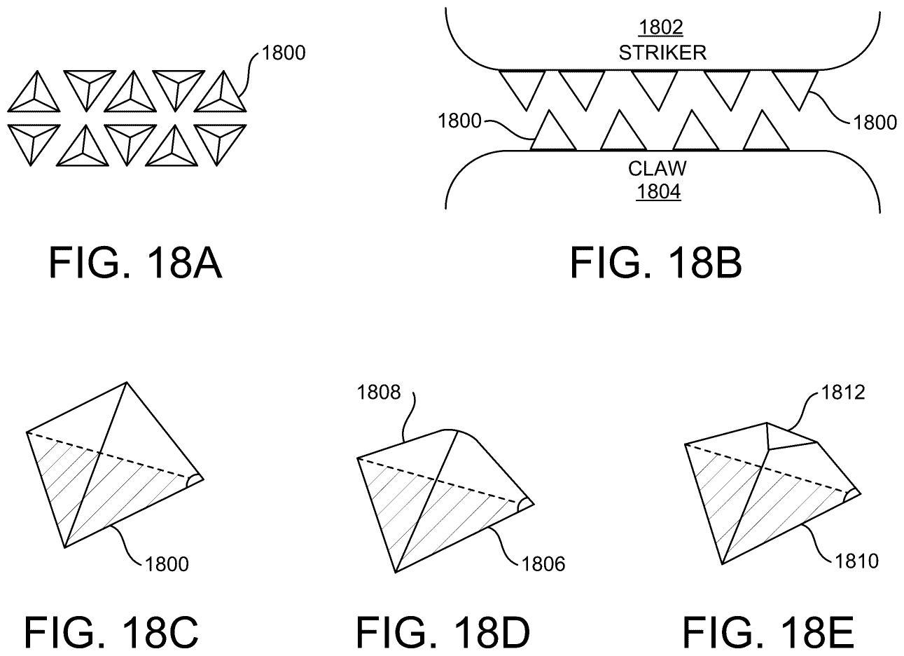

FIG. 18A shows a top view of an example of protrusions 1800 having a three-sided pyramid shape. The protrusions 1800 can be used with one or more other examples described elsewhere herein. The protrusions 1800 can be arranged in a periodic pattern. For example, the protrusions 1800 can be arranged in a grid shape. FIG. 18B shows an example of the protrusions 1800 of FIG. 17A applied to a striker 1802 and a claw 1804. That is, here both the striker 1802 and the claw 1804 have the protrusions 1800, with adjacent ones of the protrusions 1800 forming recesses for engagement. FIG. 18C shows a perspective view of one the protrusions 1800 of FIG. 18A. The one of the protrusions 1800 is here shown partially transparent for clarity. The protrusion 1800 can be a solid body (e.g., of a metal or plastic material). For example, the protrusion 1800 can be formed by knurling (e.g., of a metal material). FIG. 18D shows a perspective view of a three-sided pyramid shape 1806 having a rounded top 1808. FIG. 18E shows a perspective view of a four-sided pyramid shape 1810 having a truncated flat top 1812.

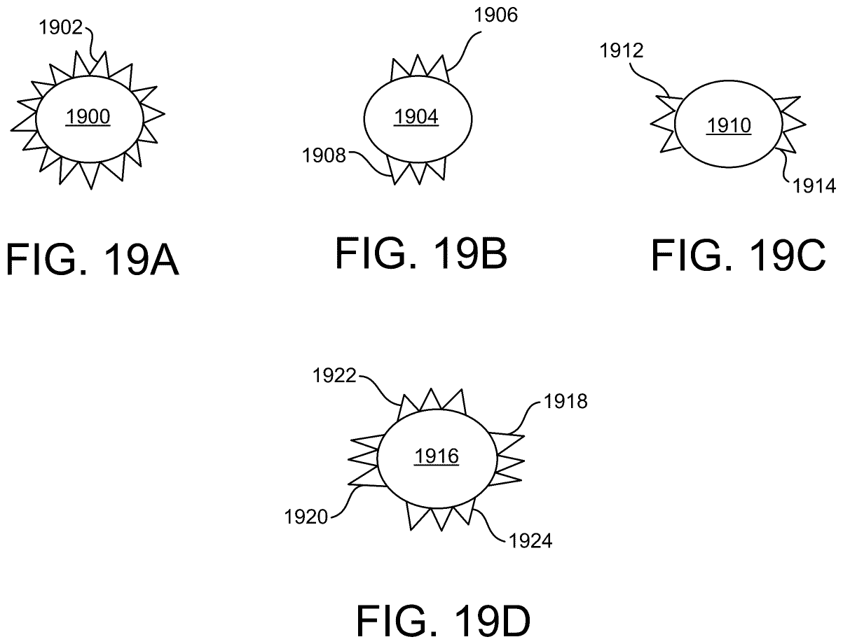

In the following, examples are described with reference to FIGS. 19A-D that describe the locations and relative positions of protrusions on an elongate member of a striker. These examples also illustrate the locations and relative positions that recesses can have on an elongate member of a striker.

FIG. 19A shows a cross section profile of a striker 1900 having protrusions 1902 that extend over an entire periphery of the cross section profile. That is, the protrusions 1902 are arranged along the periphery at equal distances from each other. This can allow the striker 1900 to engage with a claw (not shown) that abuts from any direction.

FIG. 19B shows a cross section profile of a striker 1904 having protrusions 1906 and 1908 that extend over two parts of a periphery of the cross section profile. As such, the protrusions 1906 and 1908 (e.g., ridges or pyramid shapes) can extend over one or more parts of a periphery of a cross section profile of the elongate member. Here, the protrusions 1906 and 1908 are aligned with each other in a direction that is parallel with an engagement direction of the striker 1904 when engaging the claw. For example, the movement of the striker 902 in FIGS. 9-10 illustrates the engagement direction.

FIG. 19C shows a cross section profile of a striker 1910 having protrusions 1912 and 1914 that extend over two parts of a periphery of the cross section profile. Here, the protrusions 1912 and 1914 are aligned with each other in a direction that is perpendicular to an engagement direction of the striker 1910 when engaging the claw.

FIG. 19D shows a cross section profile of a striker 1916 having protrusions 1918, 1920, 1922 and 1924 that extend over four parts of a periphery of the cross section profile. Here, the protrusions 1918 and 1920 are aligned with each other in a direction that is perpendicular to an engagement direction of the striker 1916 when engaging the claw. Here, the protrusions 1922 and 1924 are aligned with each other in a direction that is parallel with an engagement direction of the striker 1916 when engaging the claw.

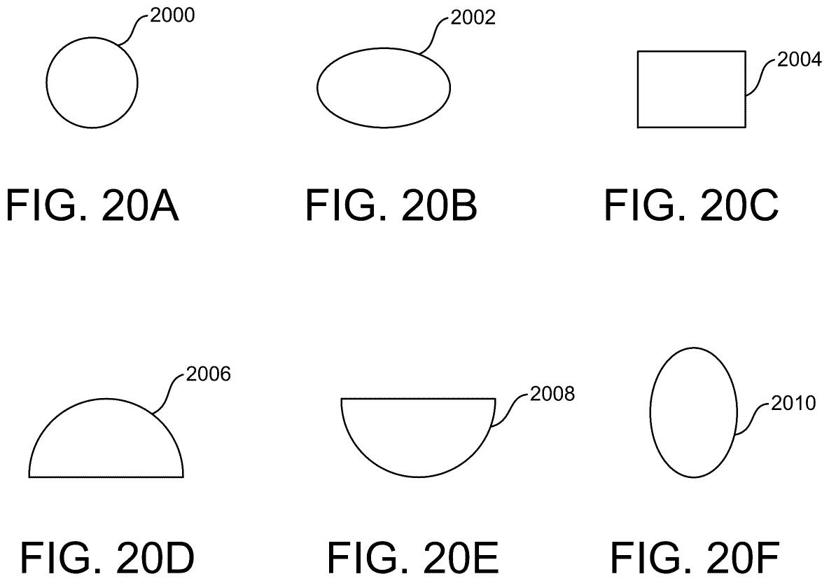

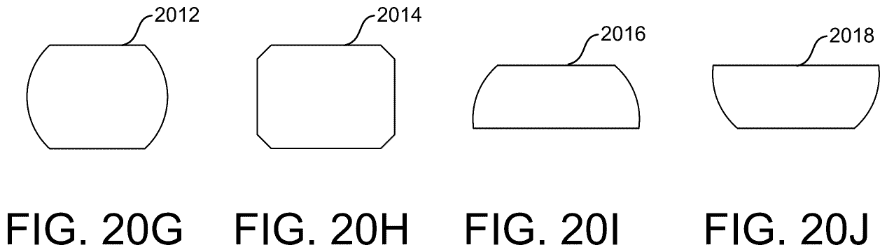

FIG. 20A shows an example of a cross section profile of a striker 2000 that is circular. The striker 2000 can be used with one or more other examples described elsewhere herein.

FIG. 20B shows an example of a cross section profile of a striker 2002 that is oval. The striker 2002 can be used with one or more other examples described elsewhere herein. A major axis of the cross section profile can be perpendicular to an engagement direction of the striker when engaging the claw. For example, the movement of the striker 902 in FIGS. 9-10 illustrates the engagement direction.

FIG. 20C shows an example of a cross section profile of a striker 2004 that is rectangular. The striker 2004 can be used with one or more other examples described elsewhere herein.

FIG. 20D shows an example of a cross section profile of a striker 2006 that is semi-circular. The striker 2006 can be used with one or more other examples described elsewhere herein. A flat side of the cross section profile can face in a direction that is parallel with an engagement direction of the striker when engaging the claw.

FIG. 20E shows another example of a cross section profile of a striker 2008 that is semi-circular. The striker 2008 can be used with one or more other examples described elsewhere herein. A flat side of the cross section profile can face in a direction that is antiparallel with an engagement direction of the striker when engaging the claw.

FIG. 20F shows another example of a cross section profile of a striker 2010 that is oval. The striker 2010 can be used with one or more other examples described elsewhere herein. A major axis of the cross section profile can be parallel with an engagement direction of the striker when engaging the claw.

FIG. 20G shows another example of a cross section profile of a striker that has a truncated circle shape 2012.

FIG. 20H shows another example of a cross section profile of a striker that has an octagonal shape 2014.

FIG. 20I shows another example of a cross section profile of a striker that has a truncated semicircle shape 2016 whose larger planar surface faces along an engagement direction of the striker when engaging the claw.

FIG. 20J shows another example of a cross section profile of a striker that has a truncated semicircle shape 2018 whose larger planar surface faces opposite to an engagement direction of the striker when engaging the claw.

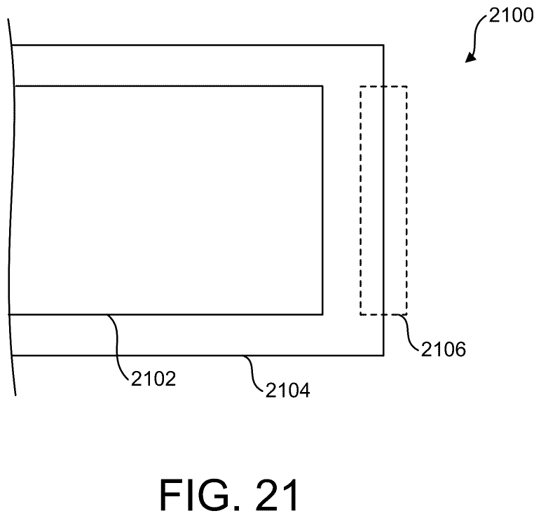

FIG. 21 shows an example cross section of a claw 2100 including a metal body 2102 covered by a polymer layer 2104. The claw 2100 can be used with one or more other examples described elsewhere herein. The polymer layer 2104 can be formed by over-molding onto the metal body 2102. An area 2106 schematically illustrates that one or more protrusions and/or one or more recesses can be formed in the polymer layer 2104.

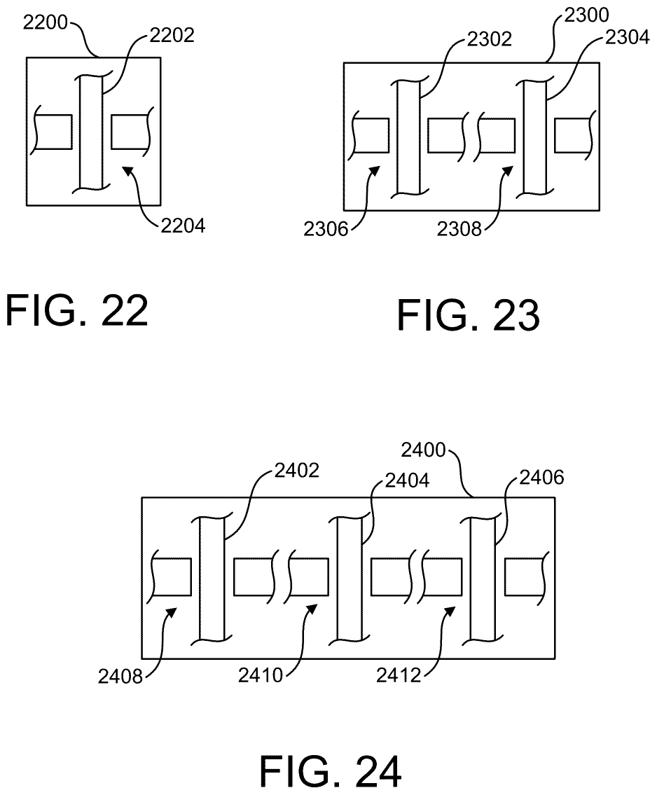

FIG. 22 schematically shows an example of a latch system 2200 having a striker 2202 and a latch assembly 2204. The latch system 2200 can be used with one or more other examples described elsewhere herein. The latch assembly 2204 has one or more claws each having a mouth for engaging with an elongate member of the striker 2202. As such, the latch system 2200 is an example of a latch system with one striker and one latch.

FIG. 23 schematically shows an example of a latch system 2300 having strikers 2302 and 2304, and latch assemblies 2306 and 2308, respectively. The latch system 2300 can be used with one or more other examples described elsewhere herein. The latch assembly 2306 has one or more claws each having a mouth for engaging with an elongate member of the striker 2302. The latch assembly 2308 has one or more claws each having a mouth for engaging with an elongate member of the striker 2304. As such, the latch system 2200 is an example of a latch system with two strikers and two latches.

FIG. 24 schematically shows an example of a latch system 2400 having strikers 2402, 2404 and 2406, and latch assemblies 2408, 2410 and 2412. The latch system 2400 can be used with one or more other examples described elsewhere herein. The latch assembly 2408 has one or more claws each having a mouth for engaging with an elongate member of the striker 2402. The latch assembly 2410 has one or more claws each having a mouth for engaging with an elongate member of the striker 2304. The latch assembly 2412 has one or more claws each having a mouth for engaging with an elongate member of the striker 2406. As such, the latch system 2300 is an example of a latch system with three strikers and three latches.

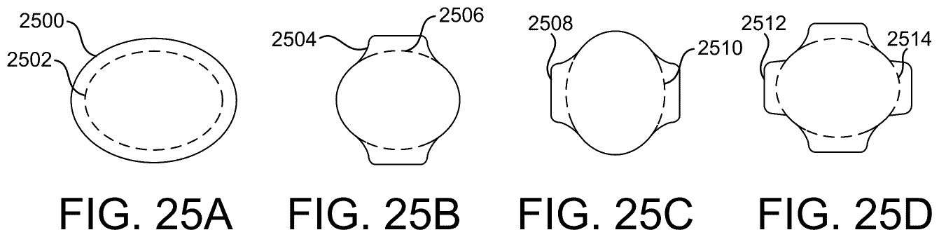

FIG. 25A shows a cross section profile of a striker 2500 (particularly, a section of an elongated portion of the striker) having recesses that extend over an entire periphery of the cross section profile. For example, the striker can have a structure analogous to that of the striker 1400 with each of the recesses extending to a depth 2502 below the surface of the striker 2500.

FIG. 25B shows a cross section profile of a striker having recesses that extend over two parts 2504 of a periphery of the cross section profile. The two parts 2504 can be aligned with each other along an engagement direction of the striker when engaging the claw. Each of the recesses extend to a depth 2506 below the surface of the two parts 2504.

FIG. 25C shows a cross section profile of a striker having recesses that extend over two parts 2508 of a periphery of the cross section profile. The two parts 2508 can be aligned with each other along a direction that is perpendicular to an engagement direction of the striker when engaging the claw. Each of the recesses extend to a depth 2510 below the surface of the two parts 2508.

FIG. 25D shows a cross section profile of a striker having recesses that extend over four parts 2512 of a periphery of the cross section profile. Two opposing ones of the four parts 2512 can be aligned with each other along an engagement direction of the striker when engaging the claw, and two other opposing ones of the four parts 2512 can be aligned with each other along a direction that is perpendicular to the engagement direction of the striker. Each of the recesses extend to a depth 2514 below the surface of the four parts 2512.

In addition to the computer simulations described with reference to FIGS. 7-8, testing on a vehicle demonstrates advantages of the present subject matter. A vehicle having a hood with a drop nose portion was tested with and without the movement restriction according to the present subject matter. In both cases, the vehicle was accelerated to 80 mph with the hood latched and the deflections at a selected point of the hood were measured during the testing. The results for the unmodified vehicle (i.e., having no movement restriction according to the present subject matter) were:

| Speed | Time | Deflection | Delta deflection |
|---|---|---|---|
| 0 mph | 0:00 s | 0.1 mm | 0.0 mm |
| 80 mph | 1:07 | 2.2 mm | 2.1 mm |
| 80 mph | 1:28 | 2.2 mm | 2.1 mm |

That is, the first row indicates that when the unmodified vehicle is stationary, the baseline deflection shown on the measuring equipment was 0.1 mm. This is defined as a delta deflection of 0.0 mm in the fourth column. The results while driving at high speed indicate substantial delta deflections compared to the baseline of 2.1 mm.

The results for the modified vehicle (i.e., having movement restriction according to the present subject matter) were:

| Speed | Time | Deflection | Delta deflection |
|---|---|---|---|
| 0 mph | 0:00 s | 1.0 mm | 0.0 mm |
| 80 mph | 0:22 s | 1.2 mm | 0.2 mm |
| 80 mph | 0:55 | 1.0 mm | 0.0 mm |

That is, the first row indicates that when the modified vehicle is stationary, the baseline deflection shown on the measuring equipment was 1.0 mm. This is defined as a delta deflection of 0.0 mm in the fourth column. The results while driving at high speed indicate delta deflections of only 0.2 mm and 0.0 mm, respectively. This is a significant reduction compared to the unmodified vehicle provided by a latch according to the present subject matter. As such unwanted movement and/or vibrations can be advantageously reduced.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one”.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

1. A latch system comprising:
a striker including an elongate member; and
a latch assembly including a base and a first claw pivotally attached to the base, the first claw including a mouth configured to restrict the elongate member when the striker is in a latched position;
wherein one of the elongate member or the mouth includes a protrusion, wherein another one of the elongate member or the mouth includes a recess, and wherein when the striker is in the latched position, the protrusion and the recess engage each other to restrict relative movement between the striker and the latch assembly in a direction along the elongate member.

2. The latch system of claim 1, wherein the protrusion comprises a ridge on the one of the elongate member or the mouth.

3. The latch system of claim 2, wherein the ridge has a shape selected from the group consisting of a V-shape, a U-shape, or a rectangular shape.

4. The latch system of claim 2, wherein the elongate member includes the ridge, and wherein the ridge extends over an entire periphery of a cross section profile of the elongate member.

5. The latch system of claim 2, wherein the elongate member includes the ridge, and wherein the ridge extends over one or more parts of a periphery of a cross section profile of the elongate member.

6. The latch system of claim 5, wherein the ridge extends over two parts of the periphery.

7. The latch system of claim 6, wherein the two parts of the periphery are aligned with each other in a direction that is parallel with an engagement direction of the striker when engaging the first claw.

8. The latch system of claim 6, wherein the two parts of the periphery are aligned with each other in a direction that is perpendicular to an engagement direction of the striker when engaging the first claw.

9. The latch system of claim 5, wherein the ridge extends over four parts of the periphery.

10. The latch system of claim 9, wherein a first part and a second part of the four parts of the periphery are aligned with each other in a direction that is parallel with an engagement direction of the striker when engaging the first claw, and wherein a third part and a fourth part of the four parts of the periphery are aligned with each other in a direction that is perpendicular to an engagement direction of the striker when engaging the first claw.

11. The latch system of claim 4, wherein the ridge traverses the elongate member in a direction that is perpendicular to a longitudinal axis of the elongate member.

12. The latch system of claim 4, wherein the ridge traverses the elongate member in a direction that is non-perpendicular to a longitudinal axis of the elongate member.

13. The latch system of claim 4, wherein the first claw includes a metal body covered by a polymer layer, and wherein the recess that is included in the mouth is formed in the polymer layer.

14. The latch system of claim 1, wherein the recess comprises a groove on the other one of the elongate member or the mouth.

15. (canceled)

16. (canceled)

17. (canceled)

18. (canceled)

19. (canceled)

20. (canceled)

21. (canceled)

22. The latch system of claim 1, wherein the protrusion comprises a pyramid shape extending from the one of the elongate member or the mouth.

23. The latch system of claim 22, wherein the pyramid shape has a rounded top.

24. The latch system of claim 22, wherein the pyramid shape has a truncated flat top.

25. The latch system of claim 22, wherein the pyramid shape is a four-sided pyramid shape.

26. The latch system of claim 22, wherein the pyramid shape is a three-sided pyramid shape.

27. (canceled)

28. (canceled)

29. (canceled)

30. (canceled)

31. (canceled)

32. (canceled)

33. (canceled)

34. (canceled)

35. (canceled)

36. The latch system of claim 1, wherein the first claw includes a metal body covered by a polymer layer, and wherein the protrusion or the recess that is included in the other one of the elongate member or the mouth is formed in the polymer layer.

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)
